(19) United States
(12) Patent Application Publication
(10) Pub. No.: US 2026/0219711 A1
(43) Pub. Date: Jul. 30, 2026

(54) ELECTRONIC DEVICE

(71) Applicant: Lenovo (Beijing) Limited, Beijing (CN)

(72) Inventors: Liang HAN, Beijing (CN); Chin-chung SHI, Beijing (CN); Dongyang WANG, Beijing (CN)

(21) Appl. No.: 19/574,059

(22) Filed: Mar. 20, 2026

Related U.S. Application Data
(63) Continuation of application No. PCT/CN2024/098609, filed on Jun. 12, 2024.

(30) Foreign Application Priority Data
Sep. 28, 2023 (CN) 202311279859.6

(51) Int. Cl. G06F 1/16

(52) U.S. Cl. CPC G06F 1/1656; G06F 1/1652

(57) ABSTRACT

An electronic device including a first body and a second body. The first body includes a fixed part, a slide part slidably connected to the fixed part, a drive assembly disposed at the fixed part and configured to drive the slide part to slide relative to the fixed part, and a flexible screen having a first edge and a second edge disposed opposite to each other. The second body is connected to the first body through a hinge. The first edge is disposed at the slide part and the second edge is disposed at the second body. The flexible screen is configured to be at least partially housed within the first body via the first edge and/or at least partially housed within the second body via the second edge, to adapt to an overall size of the fixed part and the slide part.

### CROSS-REFERENCE TO RELATED APPLICATIONS

This application is a continuation of International Application No. PCT/CN2024/098609, filed on Jun. 12, 2024, which claims priority to Chinese Application No. 202311279859.6, filed Sep. 28, 2023, the entire contents of both of which are incorporated herein by reference.

### TECHNICAL FIELD

The present disclosure generally relates to the field of computers, and, more particularly, to an electronic device.

### BACKGROUND

The overall size of an electronic device such as a laptop directly affects the size of the display screen. Minimizing the device volume while maximizing the display area has become a primary design trade-off in electronic devices.

### SUMMARY

In accordance with the disclosure, there is provided an electronic device including a first body and a second body. The first body includes a fixed part, a slide part slidably connected to the fixed part, a drive assembly disposed at the fixed part and configured to drive the slide part to slide relative to the fixed part, and a flexible screen having a first edge and a second edge disposed opposite to each other. The second body is connected to the first body through a hinge. The first edge is disposed at the slide part and the second edge is disposed at the second body. The flexible screen is configured to be at least partially housed within the first body via the first edge and/or at least partially housed within the second body via the second edge, to adapt to an overall size of the fixed part and the slide part.

### BRIEF DESCRIPTION OF THE DRAWINGS

The above and other objects, features, and advantages of exemplary embodiments of the present disclosure will become readily apparent from the following detailed description with reference to the accompanying drawings. several embodiments of the present disclosure are illustrated in the drawings by way of example and not limitation.

The same or corresponding reference numerals denote the same or corresponding parts in the drawings.

FIG. 1 is a schematic structural diagram of an electronic device consistent with the present disclosure.

FIG. 2 is another schematic structural diagram of an electronic device consistent with the present disclosure.

FIG. 3 is another schematic structural diagram of an electronic device consistent with the present disclosure.

FIG. 4 is another schematic structural diagram of an electronic device consistent with the present disclosure.

FIG. 5 is a schematic structural diagram of the first body of an electronic device consistent with the present disclosure.

FIG. 6 is another schematic structural diagram of the first body of an electronic device consistent with the present disclosure.

FIG. 7 is another schematic structural diagram of the first body of an electronic device consistent with the present disclosure.

FIG. 8 is another schematic structural diagram of the first body of an electronic device consistent with the present disclosure.

FIG. 9 is a schematic structural diagram of the drive assembly of an electronic device consistent with the present disclosure.

FIG. 10 is a schematic structural diagram of the tension mechanism of an electronic device consistent with the present disclosure.

Reference numerals: 1—First body, 11—Fixed part, 111—First end, 112—Second end, 12—Slide part, 121—Third end, 122—Fourth end, 13—Drive assembly, 131—Motor, 132—Lead screw, 133—Slider, 134—Base, 135—Guide rail, 2—Second body, 3—Flexible screen, 31—First edge, 32—Second edge, 4—Rotation sensor, 5—Tension rope, 6—Position sensor, 7—Tension mechanism, 71—Base, 72—Slide rod, 73—Slide seat, 74—Spring, 75—Pulley, 76—Limit seat, 8—First structure, 9—Second structure.

### DETAILED DESCRIPTION OF THE EMBODIMENTS

To make the objectives, features, and advantages of the present disclosure more apparent and understandable, the technical solutions of the embodiments of the present disclosure will be described below with reference to the accompanying drawings. Obviously, the described embodiments are only some embodiments of the present disclosure, and not all embodiments. Based on the embodiments of the present disclosure, all other embodiments obtained by those skilled in the art without creative effort are within the scope of the present disclosure.

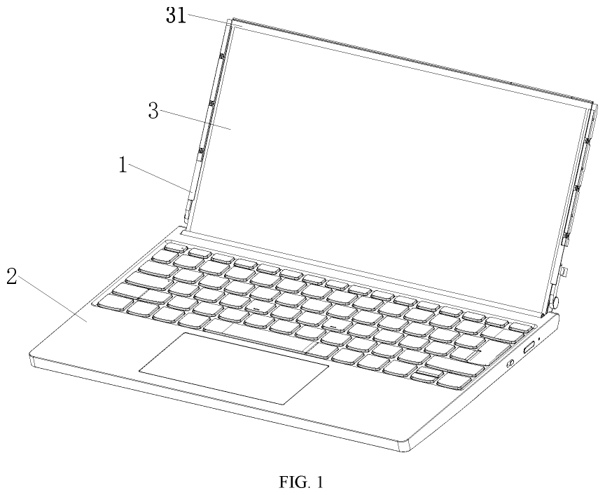

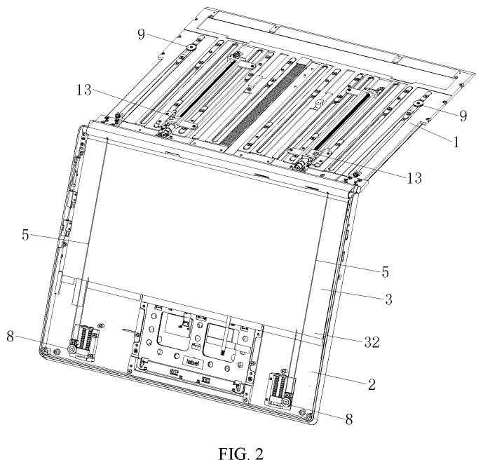

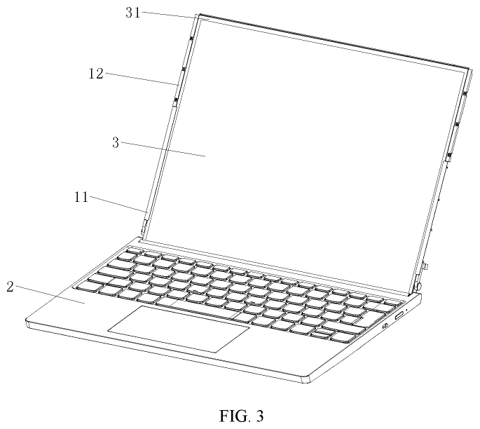

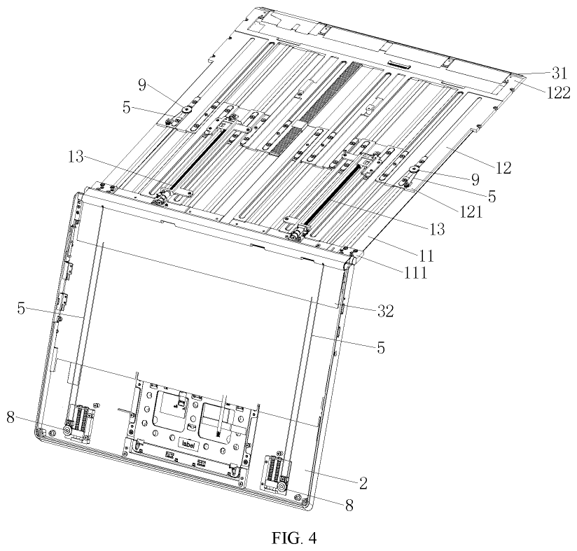

Referring to FIGS. 1 to 4, FIGS. 1 and 2 schematically show a structure when the slide part 12 is in a first position relative to the fixed part 11, with FIG. 2 showing the side opposite to that in FIG. 1. FIGS. 3 and 4 schematically show a structure when the slide part 12 is in a second position relative to the fixed part 11, with FIG. 4 showing the side opposite to that in FIG. 3. The present disclosure provides an electronic device including a first body 1 and a second body 2. The first body 1 and the second body 2 are connected by a hinge, allowing the first body 1 and the second body 2 to be folded or unfolded relative to each other. The electronic device of the present disclosure includes a laptop computer, where the first body 1 is the display unit of the laptop computer, and the second body 2 is the control unit of the laptop computer.

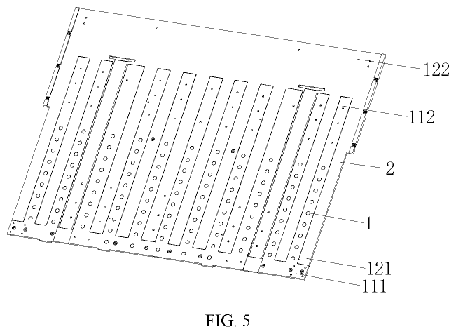

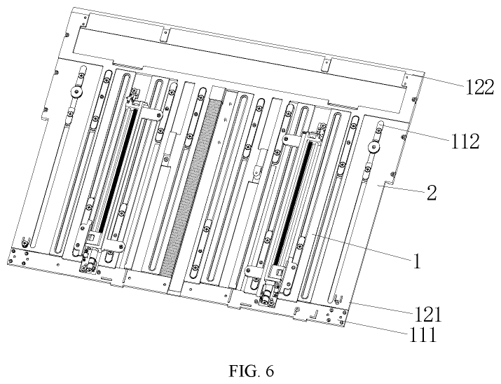

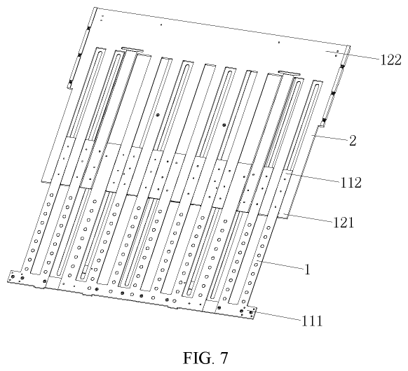

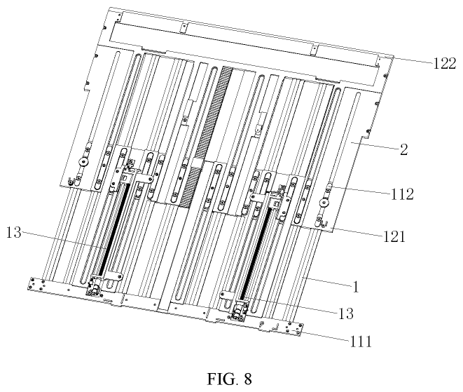

Referring to FIGS. 2, 4, and 5 to 8, FIGS. 5 and 6 schematically show a structure when the slide part 12 is in the first position relative to the fixed part 11, with FIG. 6 showing the side opposite to that in FIG. 5. FIGS. 7 and 8 schematically show a structure when the slide part 12 is in the second position relative to the fixed part 11, with FIG. 8 showing the side opposite to that in FIG. 7. The first body 1 includes a fixed part 11, a slide part 12, a drive assembly 13, and a flexible screen 3. The fixed part 11 is connected to the second body 2 via a hinge. The slide part 12 is slidably connected to the fixed part 11. The drive assembly 13 is disposed at the fixed part 11 and is used to drive the slide part 12 to slide relative to the fixed part 11. The flexible screen 3 has a first edge 31 and a second edge 32 disposed opposite to each other, the first edge 31 being disposed at the slide part 12 and the second edge 32 being disposed at the second body 2. The flexible screen 3 can be at least partially housed in the first body 1 via the first edge 31 and/or at least partially housed in the second body 2 via the second edge 32, to adapt to the overall size of the fixed part 11 and the slide part 12.

The slide part 12 slides relative to the fixed part 11, causing the overall size of the fixed part 11 and the slide part 12 to change correspondingly, i.e., the area of the first body 1 can be changed. The slide part 12 slides relative to the fixed part 11, moving closer to or away from the end connected to the second body 2.

The fixed part 11 includes a first end 111 and a second end 112, and the slide part 12 has a third end 121 and a fourth end 122, both opposite each other. The first end 111 of the fixed part 11 is connected to the second body 2 via a hinge, and the second end 112 is connected to the slide part 12. The third end 121 of the slide part 12 is closer to the first end 111 of the fixed part 11 than the fourth end 122. When the slide part 12 moves away from the first end 111 of the fixed part 11 relative to the fixed part 11, the overall size of the fixed part 11 and the slide part 12 increases; when the slide part 12 moves closer to the first end 111 of the fixed part 11 relative to the fixed part 11, the overall size of the fixed part 11 and the slide part 12 decreases.

The flexible screen 3 can adapt to the overall size of the fixed part 11 and the slide part 12. When the overall size of the fixed part 11 and the slide part 12 increases, the part of the flexible screen 3 that is housed decreases correspondingly, so that the exposed part of the flexible screen 3 adapts to the increased area of the first body 1, thereby increasing the part of the flexible screen 3 used for displaying. When the overall size of the fixed part 11 and the slide part 12 decreases, the part of the flexible screen 3 that is housed increases correspondingly, so that the exposed part of the flexible screen 3 adapts to the decreased area of the first body 1, thereby decreasing the part of the flexible screen 3 used for displaying. By moving the fixed part 11 relative to the slide part 12, the area of the first body 1 can be adapted to the second body 2 for easy carrying. Furthermore, by moving the fixed part 11 relative to the slide part 12, the area of the first body 1 can be larger than the second body 2, increasing the display size of the screen and resolving the contradiction between minimizing the size of the electronic device and maximizing the display size.

The flexible screen 3 can be partially housed within the first body 1 via the first edge 31 to adapt to the dimensional changes caused by the movement of the fixed part 11 relative to the slide part 12. The second edge 32 is fixedly connected to the first end 111 of the fixed part 11, and the flexible screen 3 is slidably connected to the fourth end 122 of the slide part 12. The first edge 31 is located within the first body 1. As the flexible screen 3 adapts to overall size changes of the fixed part 11 and the slide part 12, the amount of flexible screen 3 housed changes correspondingly. When the overall size of the fixed part 11 and the slide part 12 increases, the flexible screen 3 housed within the first body 1 is released to adapt to the increased size of the first body 1. The part of the flexible screen 3 used for displaying increases with the increase in the size of the first body 1, and the released length of the flexible screen 3 is equal to the distance by which the slide part 12 moves relative to the fixed part 11. When the overall size of the fixed part 11 and the slide part 12 decreases, the excess part of the flexible screen 3 is housed within the first body 1 via the first edge 31, and the part of the flexible screen 3 used for displaying decreases with the decrease in the size of the first body 1.

When the flexible screen 3 adapts to the size changes caused by the movement of the fixed part 11 relative to the slide part 12, the flexible screen 3 can also be partially housed within the second body 2 via the second edge 32, with the first edge 31 fixedly connected to the fourth end 122 of the slide part 12. As the flexible screen 3 adapts to the overall size changes of the fixed part 11 and the slide part 12, the amount of flexible screen 3 housed changes correspondingly. When the overall size of the fixed part 11 and the slide part 12 increases, the flexible screen 3 housed within the second body 2 is released to adapt to the increased size of the first body 1. The part of the flexible screen 3 used for displaying increases with the increase in the size of the first body 1, and the released length of the flexible screen 3 is equal to the distance by which the slide part 12 moves relative to the fixed part 11. When the overall size of the fixed part 11 and the slide part 12 decreases, the excess part of the flexible screen 3 is housed within the second body 2 via the second edge 32, and the part of the flexible screen 3 used for displaying decreases with the decrease in the size of the first body 1. Since the first edge 31 is fixed to the fourth end 122, as the overall size of the first body 1 increases, the first edge 31 moves together with the slide part 12, releasing the flexible screen 3 housed within the second body 2. When the size of the part of the flexible screen 3 used for displaying increases, the electronic device is in use, and the first body 1 opens at a certain angle relative to the second body 2, for example, the included angle is 110°. The first edge 31 is fixed to the fourth end 122, and the second edge 32 is located within the second body 2, thus preventing the flexible screen 3 from having a large folding angle during movement.

Furthermore, when the flexible screen 3 adapts to the size change caused by the movement of the fixed part 11 relative to the slide part 12, the first edge 31 is partially housed within the first body 1, while the second edge 32 is partially housed within the second body 2, and the flexible screen 3 is slidably connected to the fourth end 122. As the flexible screen 3 adapts to the change in the overall size of the fixed part 11 and the slide part 12, the amount of flexible screen 3 housed changes correspondingly. When the overall size of the fixed part 11 and the slide part 12 increases, the flexible screen 3 housed within the first body 1 and the second body 2 is released to adapt to the increased size of the first body 1. The part of the flexible screen 3 used for displaying increases with the increase in the size of the first body 1, and the released length of the flexible screen 3 is equal to the distance by which the slide part 12 moves relative to the fixed part 11. When the overall size of the fixed part 11 and the slide part 12 decreases, the excess part of the flexible screen 3 is housed within the first body 1 via the first edge 31 and the second edge 32. The part of the flexible screen 3 used for displaying decreases with the decrease in the size of the first body 1.

The drive assembly 13 is mounted on the fixed part 11. When the drive assembly 13 drives the slide part 12 to slide relative to the fixed part 11, the size of the first body 1 changes correspondingly. The flexible screen 3 adapts to the change in the size of the first body 1, thereby increasing the area of the part for displaying. The drive assembly 13, being located at the first body 1, can directly drive the slide part 12, making the movement of the slide part 12 smoother. The drive assembly 13, located at the first body 1, avoids occupying space in the second body 2, eliminating the need for redesigning the internal layout of the second body 2.

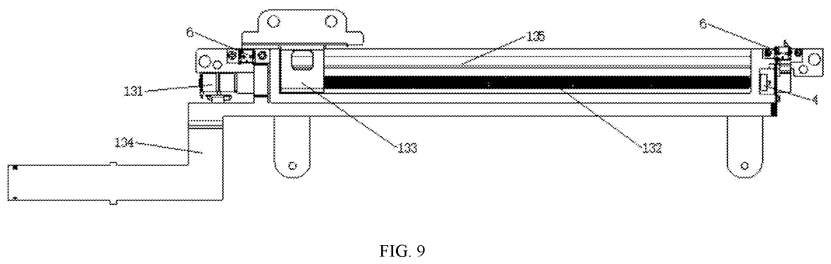

Referring to FIG. 9, in some embodiments, the drive assembly 13 includes a motor 131, a lead screw 132, and a slider 133. The motor 131 is fixed to the fixed part 11. The lead screw 132 is rotatably mounted on the fixed part 11 and rotates under the drive of the motor 131. The slider 133 is threadedly connected to the lead screw 132 and moves along the lead screw 132 as the lead screw 132 rotates. The slider 133 is fixedly connected to the slide part 12, so that the slide part 12 moves relative to the fixed part 11 under the drive of the slider 133. When the motor 131 drives the lead screw 132 to rotate, since the slider 133 is threadedly connected to the lead screw 132 and fixed to the slide part 12, the slider 133 moves axially along the lead screw 132, simultaneously causing the slide part 12 to move correspondingly. The motor 131 can drive the lead screw 132 to rotate in a first direction, and also drive the lead screw 132 to rotate in an opposite second direction. Therefore, the slider 133 can reciprocate along the axial direction of the lead screw 132, driving the slide part 12 to reciprocate, and the size of the first body 1 increases or decreases correspondingly. The slider 133 is directly fixed to the slide part 12, smoothly driving the slide part 12 to move.

Referring to FIG. 9, in some embodiments, the drive assembly 13 further includes a base 134 connected to the fixed part 11. The motor 131, lead screw 132, and slider 133 are disposed at the base 134. The drive assembly 13 is assembled into a single unit via the base 134, facilitating the assembly of electronic device.

Referring to FIG. 9, in some embodiments, the drive assembly 13 further includes a guide rail 135 disposed at the base 134. The guide rail 135 is arranged parallel to the lead screw 132, and the slider 133 is slidably connected to the guide rail 135. By setting the guide rail 135, the slider 133 can slide smoothly along the guide rail 135, ensuring smooth operation of the slider 133.

Referring to FIG. 9, in some embodiments, a rotation sensor 4 is provided at the base 134. The rotation sensor 4 is used to check the rotation state of the motor 131. The electronic device determines the operating state of the drive assembly 13 based on the signal detected by the rotation sensor 4 and the position of the slider 133. When the slider 133 moves to the target position, such as the first position or the second position, if the rotation sensor 4 detects that the motor 131 is not rotating, the electronic device determines that the drive assembly 13 is working normally; otherwise, the drive assembly 13 is malfunctioning. In some embodiments, when the slider 133 has not moved to the target position, such as the first position or the second position, if the rotation sensor 4 detects that the motor 131 is rotating, the electronic device determines that the drive assembly 13 is working normally; otherwise, the drive assembly 13 is malfunctioning. The rotation sensor 4 includes an encoder.

Referring to FIG. 9, in some embodiments, a position sensor 6 is provided at the base 134. The position sensor 6 is used to check the position of the slider 133. The electronic device instructs the motor 131 to start or stop based on the detection signal from the sensor. The slide part 12 can move relative to the fixed part 11 between a first position and a second position. In the first position, the overall size of the slide part 12 and the fixed part 11 is at the smallest; in the second position, the overall size of the slide part 12 and the fixed part 11 is at the largest. Depending on the position of the slide part 12 relative to the fixed part 11, the electronic device can have different configurations. When the slide part 12 is in the first position relative to the fixed part 11, the electronic device is in a first configuration, and the part of the flexible screen 3 used for displaying is at the smallest. When the slide part 12 is in the second position relative to the fixed part 11, the electronic device is in a second configuration, and the part of the flexible screen 3 used for displaying is at the largest.

The electronic device can have only the first configuration and the second configuration, i.e., the slide part 12 moves to either the first position or the second position relative to the fixed part 11. The position sensor 6 determines whether the slide part 12 has reached the first position or the second position by detecting the position of the slider 133 and sends a detection signal. Based on the detection signal, the electronic device instructs the motor 131 to stop when the slide part 12 moves to the first position or the second position. Two position sensors 6 can be provided, with each position sensor 6 located at one end of the lead screw 132 to detect the position of the slider 133.

The electronic device can also have intermediate configurations besides the first configuration and the second configuration, i.e., the slide part 12 can move relative to the fixed part 11 to one or more positions between the first position and the second position, allowing the electronic device to have more display sizes. The position sensor 6 can detect any position of the slider 133 between the first position and the second position. The position sensor 6 can include a slide resistor structure. As the slider 133 moves axially along the lead screw 132, the current generated by the slide resistor structure changes linearly, and the position of the slider 133 can be determined based on the current signal output by the slide resistor structure. When the slider 133 moves to the target position, the electronic device instructs the motor 131 to stop.

In some embodiments, there are at least two drive assemblies 13 arranged parallel to each other at the fixed part 11. The at least two parallelly arranged drive assemblies 13 jointly drive the slide part 12 to move relative to the fixed part 11.

In some embodiments, the second edge 32 is connected to one end of the tension rope 5, and the other end of the tension rope 5 passes around the first structure 8 provided at the second body 2 and connects to the first edge 31. Tension rope 5 connects the first edge 31 and the second edge 32, respectively, ensuring the flexible screen 3 remains flat as the flexible screen 3 adapts to changes in the overall size of the fixed part 11 and the slide part 12.

Referring to FIGS. 2 and 4, in some embodiments, the first edge 31 is fixed to the slide part 12, and the second edge 32 is disposed within the second body 2. One end of the second edge 32 is connected to the tension rope 5, and the other end of the tension rope 5 passes around the first structure 8 disposed at the second body 2 and then over the second structure 9 disposed at the fixed part 11 to connect with the slide part 12. The two ends of the tension rope 5 are located between the first structure 8 and the second structure 9.

When the slide part 12 moves relative to the fixed part 11 to the second position, since the first edge 31 is fixed to the fourth end 122 of the slide part 12, the first edge 31 of the flexible screen 3 moves together with the slide part 12, and the flexible screen 3 housed in the second body 2 is released. The second edge 32 moves towards the hinge, and the end of the tension rope 5 connected to the second edge 32 moves correspondingly. The tension rope 5 passes around the first structure 8 and the second structure 9 to pull the other end connected to the slide part 12 and moves with the slide part 12. During this process, the tension rope 5 keeps the flexible screen 3 flat.

When the slide part 12 moves relative to the fixed part 11 to the first position, since the end of the tension rope 5 connected to the slide part 12 moves correspondingly, the tension rope 5 passes around the second structure 9 and the first structure 8 to pull the end connected to the second edge 32, thereby partially housing the flexible screen 3 within the second body 2 through the second edge 32. During this process, the tension rope 5 keeps the flexible screen 3 flat.

The first structure 8 and the second structure 9 may each include a pulley 75, with the tension rope 5 passing over the pulleys 75 of the first structure 8 and the second structure 9 respectively. The pulleys 75 reduce the resistance to the movement of the tension rope 5.

In some embodiments, the tension rope 5 may have a certain degree of elasticity. The tension rope 5 includes an elastic rope, providing tension to the flexible screen 3, maintaining the tension of the flexible screen 3 and keeping the flexible screen 3 flat.

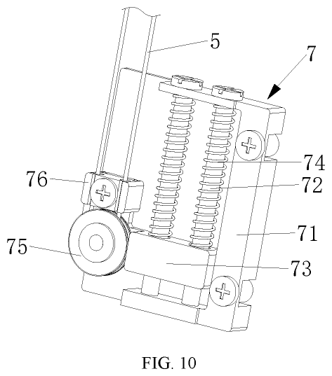

Referring to FIG. 10, in some embodiments, the second body 2 is provided with a tension mechanism 7 used to provide tension to the flexible screen 3 via the tension rope 5. At least one of the first structure 8 or the second structure 9 is a tension mechanism 7, or a separate tension mechanism 7 may be provided.

Referring to FIG. 10, in some embodiments, the tension mechanism 7 includes a base 71, a slide rod 72, a slide seat 73, a spring 74, and a pulley 75. The slide rod 72 is mounted on the base 71, and the slide seat 73 is slidably connected to the slide rod 72. Specifically, the slide seat 73 may be sleeved on the slide rod 72, and the spring 74 is sleeved on the slide rod 72. One end of the spring 74 abuts against the base 71, and the other end abuts against the slide seat 73. The pulley 75 is mounted on the slide seat 73. The tension rope 5 passes around the pulley 75. Under the action of the spring 74, the pulley 75 acts on the tension rope 5, keeping the tension rope 5 under tension. The tension rope 5 reacts to the pulley 75 to counteract the elastic force applied by the spring 74 to the slide seat 73. When the first structure 8 is the tension mechanism 7, the base 71 is fixed to the second body 2. When the second structure 9 is the tension mechanism 7, the base 71 is connected to the fixed part 11. There can be two slide rods 72 arranged in parallel, and a spring 74 is sleeved on each slide rod 72.

The tension mechanism 7 may also include a limit seat 76 mounted on the base 71 and has two limiting grooves. The two ends of the tension rope 5, which passes around the pulley 75, are respectively located in one limiting groove. The limit seat 76 prevents the tension rope 5 from detaching from the pulley 75.

In some embodiments, the first body 1 is equipped with an attitude sensor, which detects the attitude of the first body 1 relative to the second body 2. The electronic device controls the drive assembly 13 based on the signal detected by the attitude sensor. The attitude sensor can detect whether the electronic device is in use. When the angle of the first body 1 relative to the second body 2 reaches a certain range, the electronic device can be determined is in use. The electronic device can then control the drive assembly 13 to start to adjust the position of the slide part 12 relative to the fixed part 11, thereby automatically adjusting the area of the part of the flexible screen 3 for displaying.

The movement of the slide part 12 relative to the fixed part 11 can also be achieved through user operation. The electronic device may include adjustment keys. Users operate the adjustment keys by pressing, pushing, or other actions, causing the drive assembly 13 to move the slide part 12 relative to the fixed part 11 to a corresponding position.

In some embodiments, after the electronic device is turned on, the user presses the adjustment key, activating the drive assembly 13 and moving the slide part 12 relative to the fixed part 11 from a first position to a second position. The adjustment key is pressed again, and the drive assembly 13 moves the slide part 12 relative to the fixed part 11 from the second position back to the first position.

In some embodiments, when the electronic device receives a power-off instruction, the electronic device instructs the drive assembly 13 to move the slide part 12 relative to the fixed part 11 from the second position to the first position.

In some embodiments, the user pushes the adjustment key in a first direction, causing the drive assembly 13 to move the slide part 12 relative to the fixed part 11 from the first position to the second position. The drive assembly 13 stops when the user releases the adjustment key or the slide part 12 reaches the second position. Pushing the adjustment key in a second direction causing the drive assembly 13 moves the slide part 12 relative to the fixed part 11 from the second position back to the first position. The drive assembly 13 stops when the user releases the adjustment key or the slide part 12 reaches the first position.

The various processes shown above can be used with processes rearranged, added, or deleted. For example, the processes described in the present disclosure can be executed in parallel, sequentially, or in different orders, as long as the desired result of the technical solution disclosed in the present disclosure is achieved, and the present disclosure is not limited on this.

Furthermore, the terms “first” and “second” are used for descriptive purposes only and should not be construed as indicating or implying relative importance or implicitly specifying the number of indicated technical features. Thus, a feature defined as “first” or “second” may explicitly or implicitly include at least one of that feature. In the description of the present disclosure, “a plurality of” means two or more, unless otherwise explicitly specified.

The above description is merely of embodiments of the present disclosure, but the scope of the present disclosure is not limited thereto. Any variations or substitutions that can be easily conceived by those skilled in the art within the scope of the technology disclosed in the present disclosure should be included within the scope of the present disclosure. Therefore, the scope of the invention should be determined by the scope of the claims.

What is claimed is:

1. An electronic device comprising:
a first body including:
a fixed part;
a slide part slidably connected to the fixed part;
a drive assembly disposed at the fixed part and configured to drive the slide part to slide relative to the fixed part; and
a flexible screen having a first edge and a second edge disposed opposite to each other; and
a second body, connected to the first body through a hinge;
wherein:
the first edge is disposed at the slide part and the second edge is disposed at the second body; and
the flexible screen is configured to be at least partially housed within the first body via the first edge and/or at least partially housed within the second body via the second edge, to adapt to an overall size of the fixed part and the slide part.

2. The electronic device according to claim 1, wherein the drive assembly includes:
a motor, fixed to the fixed part;
a lead screw rotatably disposed at the fixed part, and configured to be driven by the motor to rotate; and
a slider, threadedly connected to the lead screw, and configured to move along the lead screw as the lead screw rotates, the slider being fixedly connected to the slide part to drive the slide part to move relative to the fixed part.

3. The electronic device according to claim 2, wherein:
the drive assembly further includes a base connected to the fixed part; and
the motor, the lead screw, and the slider are disposed at the base.

4. The electronic device according to claim 3, wherein:
the drive assembly further includes a guide rail disposed at the base and parallel to the lead screw; and
the slider is slidably connected to the guide rail.

5. The electronic device according to claim 3, wherein a rotation sensor is provided at the base, the rotation sensor being used to check a rotation state of the motor, and the electronic device determining an operating state of the drive assembly based on a signal detected by the rotation sensor and a position of the slider.

6. The electronic device according to claim 3, wherein a position sensor is provided at the base and configured to check a position of the slider to provide a detection signal, according to which the electronic device instructs the motor to start or stop.

7. The electronic device according to claim 1, wherein the drive assembly is one of at least two drive assemblies arranged parallel to each other at the fixed part.

8. The electronic device according to claim 1, wherein the second edge is connected to one end of a tension rope, and another end of the tension rope passes around a structure disposed at the second body and connects to the first edge.

9. The electronic device according to claim 8, wherein a tension mechanism is provided at the second body and is configured to provide tension force to the flexible screen through the tension rope.

10. The electronic device according to claim 1, wherein an attitude sensor is provided at the first body and is configured to detect an attitude of the first body relative to the second body to generate a signal, according to which the electronic device controls the drive assembly.
